(19) United States
(12) Patent Application Publication
(10) Pub. No.: US 2013/0096870 A1
(43) Pub. Date: Apr. 18, 2013

(54) CONTROL METHOD APPLIED TO EDGE DETECTION APPARATUS AND CONTROL APPARATUS THEREOF

(71) Applicant: Ting-Yuan Cheng, Taipei (TW)

(72) Inventor: Ting-Yuan Cheng, Taipei (TW)

(21) Appl. No.: 13/569,192

(22) Filed: Aug. 8, 2012

(30) Foreign Application Priority Data
Oct. 14, 2011 (TW) 100137350

(51) Int. Cl. G06F 19/00

(52) U.S. Cl. 702/150

(57) ABSTRACT

A control method applied to an edge detection apparatus is provided, wherein the edge detection apparatus includes a light emitting device, and the edge detection apparatus receives an output light of the light emitting device driven by a driving signal in order to generate a sensed signal. The method includes determining a first intensity difference value corresponding to a difference between high and low intensities of the sensed signal; adjusting the driving signal and accordingly determining a second intensity difference value corresponding to a difference between high and low intensities of the sensed signal in response to adjusting of the driving signal; comparing the first intensity difference value and a second intensity value to generate a comparison result; and adjusting the driving signal according to the comparison result.

### BACKGROUND OF THE INVENTION

1. Field of the Invention

The present invention relates generally to an edge detection device of a printing apparatus, and more particularly, to a method and a control apparatus device for controlling output power of a light emitting device of the edge detection device.

2. Description of the Prior Art

Edge detection is used when a same content is continuously printed (e.g. label printing) on a huge amount of print mediums having the same size. Edge detection confirms a position of an edge of each print medium such that a starting reference point of printing can be determined, thereby ensuring printing results on each print medium are substantially the same.

A conventional edge detection arrangement is illustrated in FIG. 1. As shown, an edge detection system 120 includes a light emitting device 122 employed for emitting light, and a light sensor 124 employed for receiving the light emitted by the light emitting device 122 to generate a sensed signal. The edge detection device 120 is utilized for detecting edges of each print medium 12 on a print medium sheet 10. The print medium 12 is carried by a thin substrate 13. The print mediums 12 are supported by the thin substrate 13 and separated from each other by an interval 11 therebetween. The intervals 11 are also portions of the thin substrate 13. The light sensor 124 may generate sensed signals with different intensities when the light is incident upon the print mediums 12 or the thin substrate 13, as well as different positions of different materials. When the light is emitted exactly upon the thin substrate 13 (i.e. the interval 11), the sensed signal will have higher intensity due to the high transmittance of the thin substrate 13. In the case of the light being emitted upon the print medium 12, the sensed signal will have lower intensity due to the low transmittance of the print medium 12. Referring to the waveform illustrated in FIG. 2A, peaks of the sensed signal represent a center of the interval 11 crossing the light sensor 124 because the center of the interval 11 normally has a highest transmittance. As a result, the position of the center of the interval can be confirmed.

When the position of the center of the interval 11 is confirmed, a threshold value TH for slicing the sensed signal is configured. When the intensity of the sensed signal is lower than the threshold value TH, it is determined that the print medium 12 is currently crossing the light sensor 124. If the intensity of the sensed signal is higher than the threshold value TH, it is determined that the interval 11 is currently crossing the light sensor 124. By doing so, the edge between the interval 11 and the print medium 12 can be determined, which can serve as a starting reference point of printing

The threshold value TH is somewhere in the middle between a maximum value (peak H) and a minimum value (L) of the sensed signal, such as the line designated as TH in FIG. 2A. Due to some noise in the sensed signal, however, the actual waveform of the sensed signal will be similar to that shown in FIG. 2B. In addition, the difference between the maximum value H and the minimum value L of the sensed signal varies with the intensity of the output light generated by the light emitting device 122. With the higher intensity of output light generated by the light emitting device 122, the difference between the maximum value and the minimum value of the sensed signal increases, and vice versa. If the intensity of the output light generated by the light emitting device 122 exceeds a certain level, the waveform of the sensed signal will be similar to that shown in FIG. 2C. In FIG. 2C, the waveform of the sensed signal is generated based on the light emitting device 122 having high output power. The difference between high and low intensities of such sensed signal is not as obvious as those in FIG. 2A and FIG. 2B. This is because the output light of the light emitting device 122 is strong enough to partially penetrate the print medium 12. As a result, the minimum value L of the sensed signal is increased, causing the difference between the minimum value L and the maximum value H to decrease. Additionally, in this case, the noise further causes the shape of the sensed signal to be ambiguous (i.e. more than one peak) resulting in the maximum value H and the minimum value L becoming too close to accurately determine a proper threshold value TH. Therefore, there is a need to provide a mechanism which can control output power of the light emitting device, thereby maintaining the output power of the light emitting device within a proper range to successfully and accurately detect the edges of the print medium.

### SUMMARY OF THE INVENTION

With this in mind, it is one objective of the present invention to provide a method of controlling an edge detection device and a related control apparatus, which can be applied to the control over output power of a light emitting device in the edge detection device, thereby maintaining the output power of the light emitting device within a proper range such that uncertainties of edge detection caused by exceeding output power can be avoided.

A first aspect of the present invention provides a method of controlling an edge detection device. The edge detection device comprises a light emitting device, and receives an output light generated by the light emitting device that is driven by a driving signal to generate a sensed signal. The method comprises: determining a first intensity difference value corresponding to a difference between high and low intensities of the sensed signal; adjusting the driving signal and accordingly determining a second intensity difference value corresponding to a difference between high and low intensities of the sensed signal in response to adjusting of the driving signal; comparing the first intensity difference value and the second intensity difference value to generate a comparison result; and adjusting the driving signal according to the comparison result.

A second aspect of the present invention provides a control apparatus that is used in an edge detection device, wherein the edge detection device comprises a light emitting device, and receives an output light generated by a light emitting device that is driven by a driving signal to generate a sensed signal. The control apparatus comprises an adjusting module, a sensed signal intensity detecting module, an error calculating module. The adjusting module is employed for adjusting the driving signal. The sensed signal intensity detecting module is employed for determining a first intensity difference value corresponding to a difference between high and low intensities of the sensed signal and determining a second intensity difference value corresponding to a difference between high and low intensities of the sensed signal in response to adjusting of the driving signal by the adjusting module. The error calculating module is coupled to the sensed signal intensity detecting module, and employed for comparing the first intensity difference value and the second intensity difference value to generate a comparison result. Additionally, the adjusting module further adjusts the driving signal in accordance with the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a simplified diagram showing a conventional edge detection device.

FIGS. 2A-2C depict waveforms of a sensed signal generated by a conventional edge detection device.

FIG. 3 depicts a function between the intensity difference value and the intensity of the driving signal.

FIG. 4 depicts a block diagram of a control apparatus according to one exemplary embodiment of the present invention.

FIG. 5 depicts a shifted function due to aging of the light emitting device.

FIG. 6 depicts a flow chart of a control method according to one exemplary embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

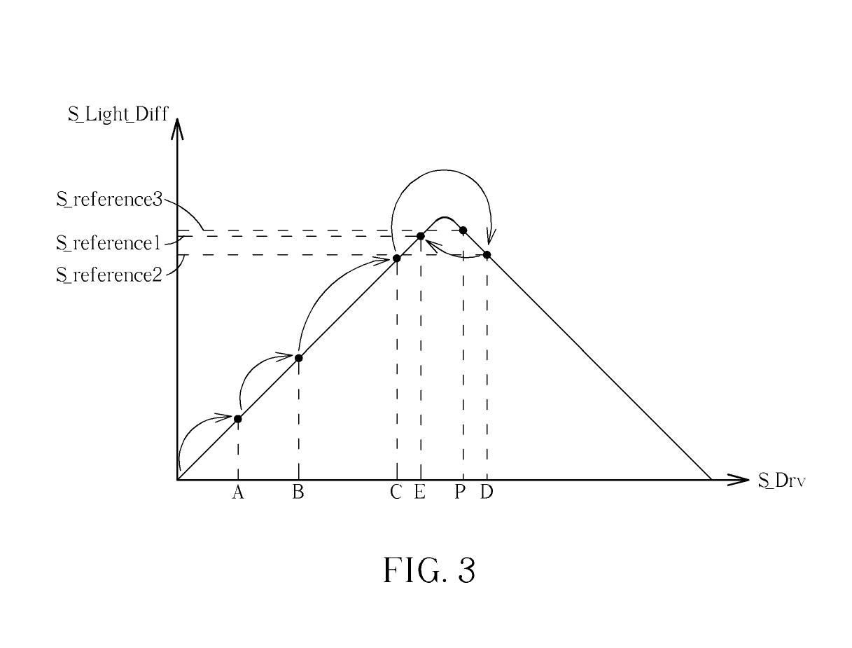

Please refer to FIG. 3, which depicts intensity difference values between high and low intensities (e.g. a maximum value and a minimum value) of a sensed signal with respect to an intensity of a driving signal for a light emitting device (wherein output power of the light emitting device is in proportion to the intensity of the driving signal). As depicted, when the intensity of the driving signal for the light emitting device is smaller than P, the intensity difference value of the sensed signal is directly proportional to the intensity of the driving signal. When the intensity of the driving signal is greater than P, the intensity difference value of the sensed signal is inversely proportional to the intensity of the driving signal. Hence, it is suitable to maintain the intensity of the driving signal of the light emitting device around P. This causes the intensity difference value of the sensed signal to be largest, which is advantageous to the edge detection.

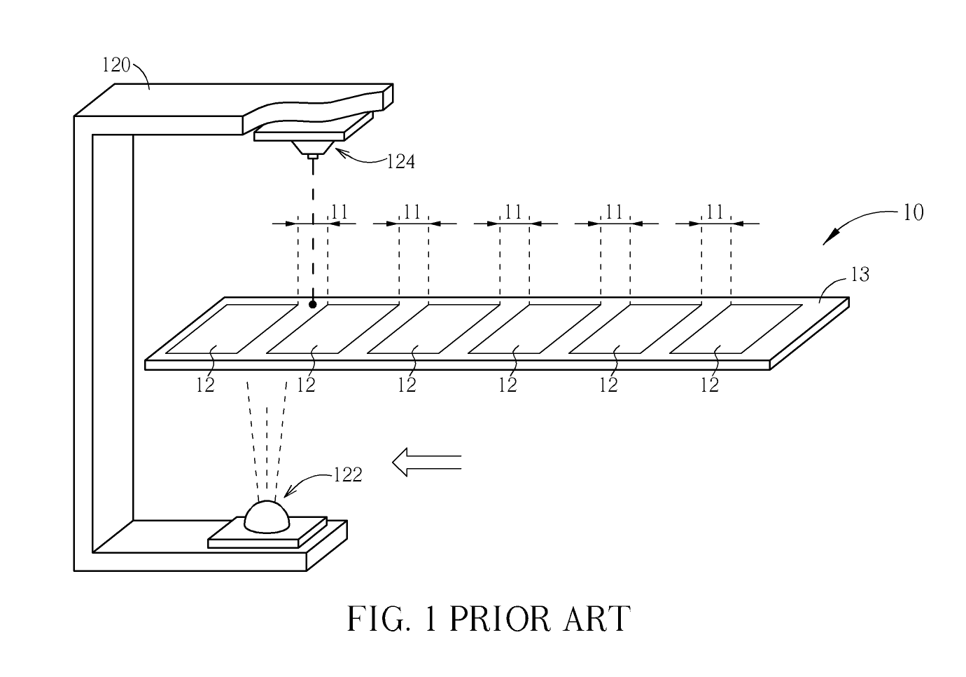

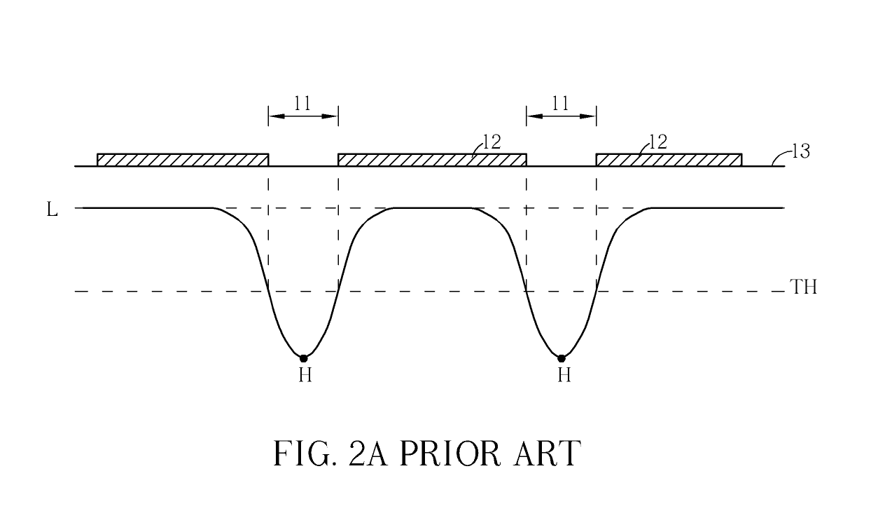

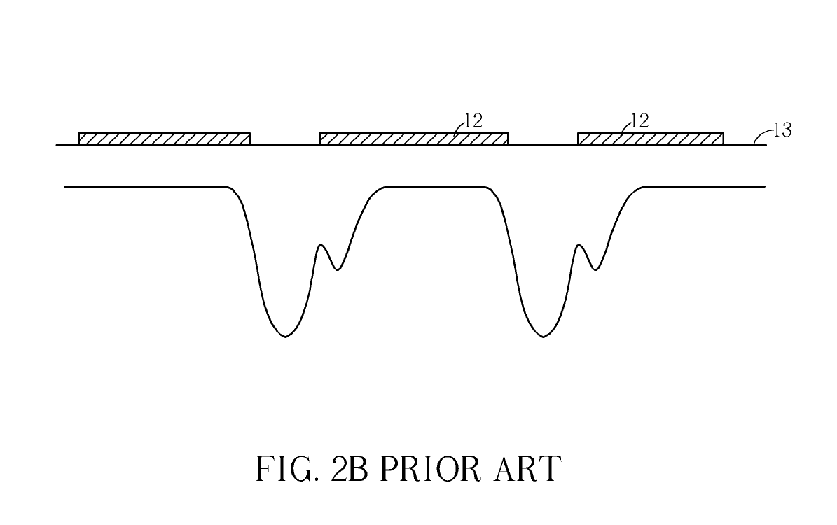

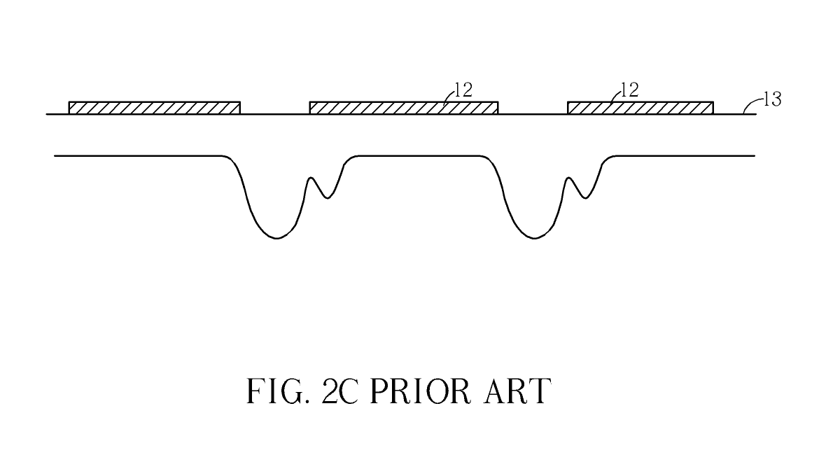

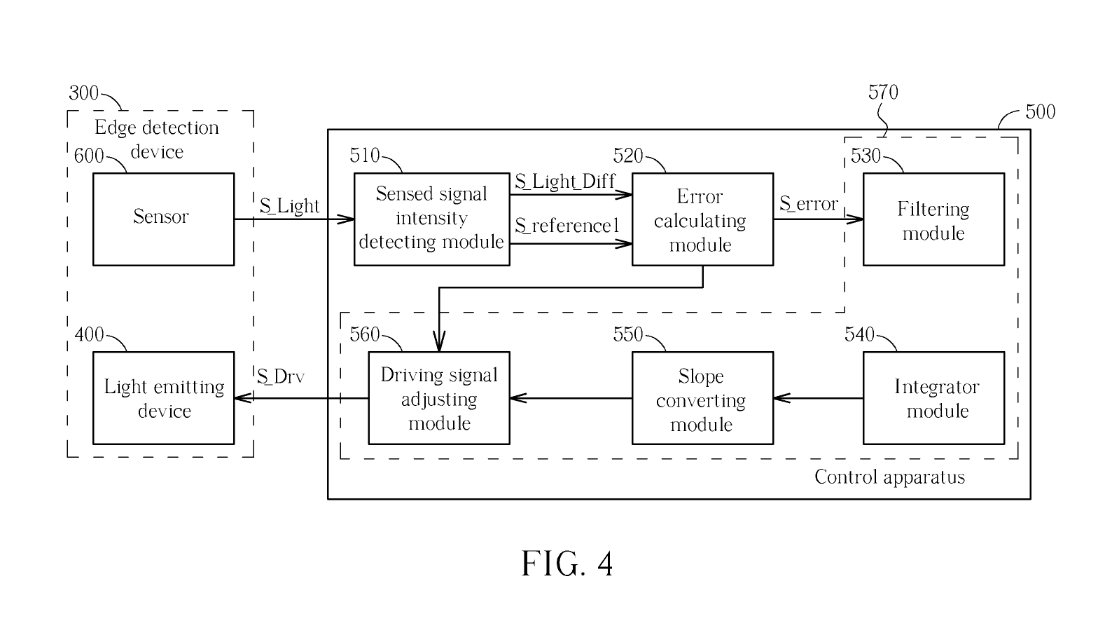

Operations of the control apparatus of the present invention will become more apparent from the following description. Please refer to FIG. 3 in conjunction with FIG. 4. FIG. 4 is a block diagram of a control apparatus according to one exemplary embodiment of the present invention. As depicted, the control apparatus 500 is coupled to an edge detection device 300. The edge detection device 300 comprises a light emitting device 400 and a sensor 600. The control apparatus 500 is employed for adjusting a driving signal S_Dry for driving the light emitting device 400 according to a sensed signal S_Light generated by the sensor 600. According to various embodiments of the invention, the driving signal S_Dry may be generated by the control apparatus 500. Alternatively, the driving signal S_Dry may be generated by other circuits in advance and then be adjusted by the control apparatus 500. The control apparatus 500 includes a sensed signal intensity detecting module 510, an error calculating module 520, a filtering module 530, an integrator module 540, a slope converting module 550 and a driving signal adjusting module 560. The sensed signal intensity detecting module 510 calculates a difference between a maximum value and a minimum value of the sensed signal S_Light to generate an intensity difference value S_Light_Diff. The sensed signal intensity detecting module 510 serves a relative maximum value of the sensed signal S_Light over a period of time as the maximum value, which may be the peak H generated at the center point of the interval 11 as shown in FIG. 1. Additionally, the sensed signal intensity detecting module 510 serves an average value of the sensed signal S_Light over a period of time as the minimum value, which is the average value of the sensed signal generated over a range of a print medium 12. When the intensity difference value S_Light_Diff is determined, the error calculating module 520 calculates an error value S_error between a previously determined intensity difference value S_Light_Diff and a currently determined intensity difference value S_Light_Diff. The control apparatus 500 then adjusts the intensity of the driving signal S_Dry in accordance with the error value S_error.

At the beginning of the operation of the control apparatus 500, the driving signal adjusting module 560 increases the intensity (which may refer to a voltage value or a current value) of the driving signal S_Dry from zero to A. At this time, the currently determined intensity difference value S_Light_Diff (i.e. the difference determined when the driving signal S_Dry has the intensity of A) is greater than the previously determined intensity difference value S_Light_Diff′ (i.e. the difference determined when the driving signal S_Dry has the intensity of 0). As a result, the driving signal adjusting module 560 keeps increasing the intensity of the driving signal S_Dry according to the result of the intensity detecting module 510, where the driving signal S_Dry is increased step by step till the intensity of the driving signal S_Dry has been increased to B. According to various embodiments of the present invention, the driving signal adjusting module 560 may directly adjust and output the adjusted driving signal S_Drv. Alternatively, it is possible that the driving signal adjusting module 560 only outputs an adjusting step value and an external circuit/module accordingly adjusts the driving signal S_Dry according to the adjusted step value. Before the intensity of driving signal S_Dry is increased step by step to C, the intensity difference value S_Light_Diff determined at C (i.e. the intensity difference determined when the driving signal S_Dry has the intensity of C) is still greater than the intensity difference value S_Light_Diff determined at B. At this time, the driving signal adjusting module 560 may either keep increasing the intensity of driving signal S_Dry or temporarily stop increasing the intensity of the driving signal S_Dry according to various embodiments of the invention. If the driving signal adjusting module 560 keeps increasing the intensity of the driving signal S_Dry and the intensity of the driving signal S_Dry is increased to D, it can be known from the detection result of the intensity detecting module 510 that the currently determined intensity difference value S_Light_Diff is smaller than the previously determined intensity difference value S_Light_Diff′. Accordingly, the intensity of driving signal S_Dry will be decreased to C or E. At this time, a precise fine tuning method will be used instead of the step-by-step method, to maintain the driving signal S_Dry having a steady intensity. The fine tuning method is explained below.

At first, the error calculating module 520 serves an intensity difference value S_referencel or S_reference2 that is determined based on a current intensity of the driving signal S_Dry (i.e. C or E) as a reference value. The error calculating module 520 compares the reference value with the currently determined intensity difference value S_Light_Diff to generate the error value S_error. According to the error value S_error, the filtering module 530 generates a filtered result. The integrator module 540 performs an integration operation on the filtered result to generate an integration result. Then, the slope converting module 550 will perform a slope conversion on the integration result to generate a driving signal compensation value, wherein the slope conversion is performed based on a slope of line AB (or any other lines parallel to line AB). Actually, the error value S_error generated by the error calculating module 520 is equal to a difference value on the Y-axis of FIG. 3, which is also a difference between the different intensity difference values. Hence, it is necessary to convert the error value S_error into a corresponding value on the X-axis by the slope converting module 550, in order to obtain the driving signal compensation value for adjusting the intensity of the driving signal S_Dry to control the light emitting device 400. The driving signal adjusting module 560 then adjusts the intensity of the driving signal S_Dry according to the driving signal compensation value. With the operations of the above-mentioned circuits, when a referenced intensity difference value (i.e. S_referencel or S_reference2) is greater than the currently determined intensity difference value (S_Light_Diff), an adjusting module 570 comprising the abovementioned circuits (530, 540, 550, 560) performs a series of operations: obtaining the error, filtering, and integration to increase the intensity of the driving signal S_Drv. The adjusting module 570 can also decrease the intensity of the driving signal S_Drv. If parameters (e.g. time constants of the filtering module 530 or the integrator module 540) are appropriately configured, the intensity of the driving signal S_Dry will be maintained at the intensity C (corresponding to the reference value S_referencel) or at the intensity E (corresponding to the reference value S_reference2). That is, once it is found that the intensity difference value becomes lower after the driving signal S_Dry is adjusted, the adjusting module 570 will pull the intensity of the driving signal S_Dry back to the previous value. If the intensity difference value becomes greater after the driving signal S_Dry is adjusted, the intensity of driving signal S_Dry will be continually increased.

Under some conditions, if the reference value of the error calculating module 520 is selected as value S_reference3 corresponding to the intensity of P and the currently determined intensity difference value is S_reference2, the intensity of the driving signal S_Dry will be increased. According to the tuning mechanism mentioned above, the intensity of the driving signal S_Dry will be increased toward the right side along the X axis. The intensity difference value S_Light_Diff will continually decrease. As a result, the intensity difference value S_Light_Diff will always be smaller than the reference value S_reference3 such that it finally fails to steadily control the light emitting device 400. To prevent this, if the driving signal adjusting module 560 finds that the driving signal compensation value (generated by the slope converting module 550) remains positive for several cycles of operations, it is acknowledged that the intensity of driving signal S_Dry is currently at P, and the intensity of the driving signal S_Dry will therefore be decreased. This can be achieved by disposing an inverting circuit in the driving signal adjusting module 560, which is used to invert the driving signal compensation value. Please note that the above-mentioned control apparatus 500 can be implemented as software executed by a processor, hardware circuits or structures, or a combination of both. All of these possible implementations should be considered as within the scope of the present invention.

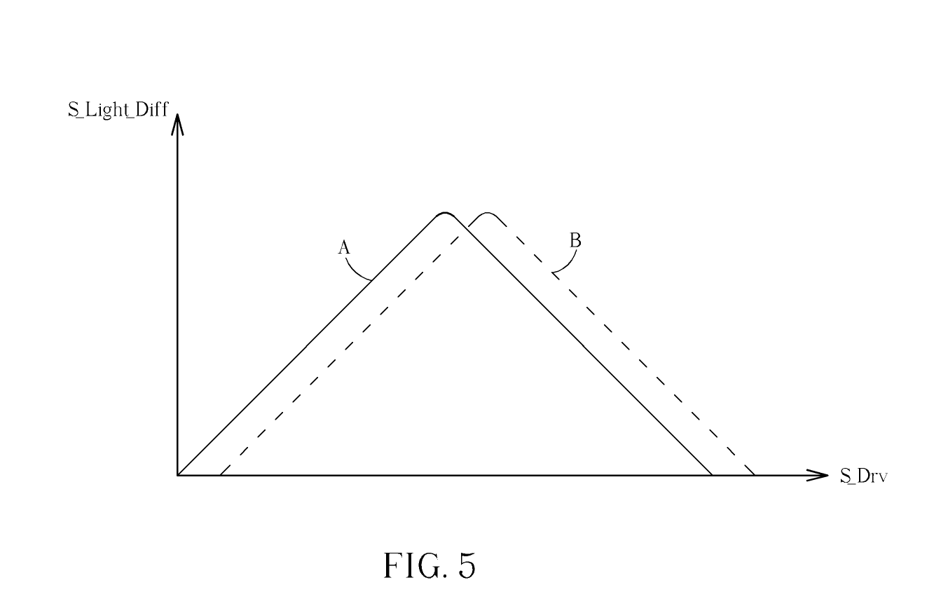

Advantages of the present invention include eliminating noise as well as preventing the aging problem of the light emitting device. As shown in FIG. 5, if the light emitting device is aged, the function between the intensity difference value and the intensity of the driving signal will shift, and it becomes difficult to obtain a proper operating point of the light emitting device. With the control mechanism of the present invention, the intensity of the driving signal of the light emitting device can still be maintained within a relatively proper range.

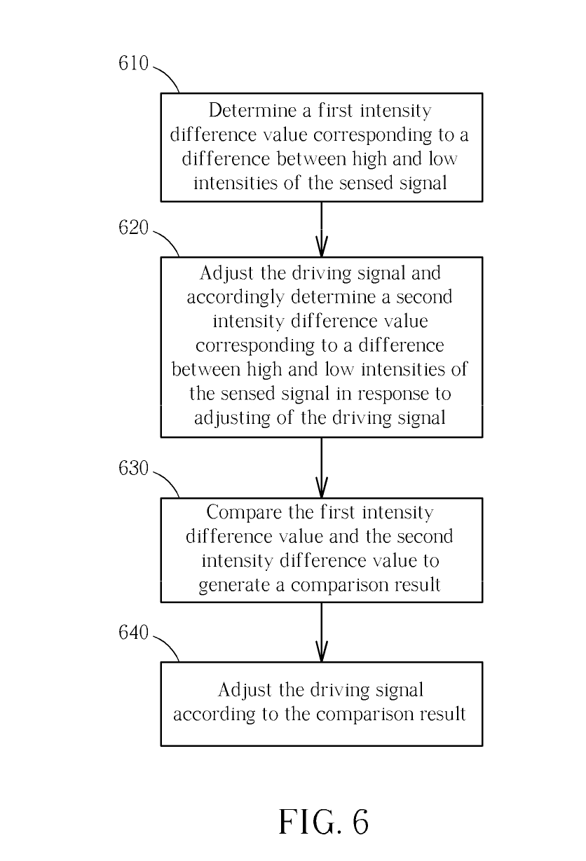

According to one exemplary embodiment of the present invention, a method for controlling an edge detection device is provided. An exemplary flow chart thereof is illustrated in FIG. 6. The method comprises the following steps:

Step 610: determine a first intensity difference value corresponding to a difference between high and low intensities of the sensed signal;

Step 620: adjust the driving signal and accordingly determine a second intensity difference value corresponding to a difference between high and low intensities of the sensed signal in response to adjusting of the driving signal;

Step 630: compare the first intensity difference value and the second intensity difference value to generate a comparison result; and

Step 640: adjust the driving signal according to the comparison result.

As the operations of each step in the method have been thoroughly explained before, a detailed description is omitted here for the sake of brevity.

In conclusion, the present invention provides a control apparatus and a method of controlling an edge detection device which can steadily control the intensity of the output light of the light emitting device, thereby assuring the quality of the sensed signal and improving the accuracy of edge detection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling an edge detection device, wherein the edge detection device comprises a light emitting device, and receives an output light generated by the light emitting device driven by a driving signal in order to generate a sensed signal , the method comprising:
determining a first intensity difference value corresponding to a difference between high and low intensities of the sensed signal;
adjusting the driving signal and accordingly determining a second intensity difference value corresponding to a difference between high and low intensities of the sensed signal in response to adjusting of the driving signal;
comparing the first intensity difference value and the second intensity difference value to generate a comparison result; and
adjusting the driving signal according to the comparison result.

2. The method of claim 1, wherein the step of adjusting the driving signal according to the comparison result comprises:
increasing an intensity of the driving signal when the comparison result indicates the first intensity difference value is smaller than the second intensity difference value; and
decreasing the intensity of the driving signal when the comparison result indicates the first intensity difference value is greater than the second intensity difference value.

3. The method of claim 1, wherein the step of adjusting the driving signal according to the comparison result comprises:
increasing an intensity of the driving signal when the comparison result indicates the first intensity difference value is greater than the second intensity difference value; and
decreasing the intensity of the driving signal when the comparison result indicates the first intensity difference value is smaller than the second intensity difference value.

4. The method of claim 1, wherein the step of adjusting the driving signal according to the comparison result comprises:
increasing an intensity of the driving signal when the comparison result indicates the first intensity difference value is greater than the second intensity difference value; and
decreasing the intensity of the driving signal if increasing of the intensity of the driving signal makes the comparison result indicate the first intensity difference value is greater than the second intensity difference value.

5. The method of claim 1, wherein the step of adjusting the driving signal according to the comparison result comprises:
calculating an error value between the first intensity difference value and the second intensity difference value;
performing a filtering operation on the error value to generate a filtered result;
performing an integration operation on the filtered result to generate an integration result; and
adjusting the driving signal according to the integration result.

6. The method of claim 5, wherein the step of adjusting the driving signal according to the integration result comprises:
performing a slope conversion on the integration result to generate a driving signal compensation value; and
adjusting the driving signal according to the driving signal compensation value;
wherein the slope conversion is performed based on a relation between the first intensity difference value and the second intensity difference value in response to adjusting of the driving signal.

7. The method of claim 1, wherein the step of determining the first intensity difference value comprises:
determining an average value of the sensed signal over a specific period of time;
determining a maximum value of the sensed signal; and
determining the first intensity difference value according to the average value and the maximum value.

8. The method of claim 1, wherein the step of determining the second intensity difference value comprises:
determining an average value of the sensed signal over a specific period of time;
determining a maximum value of the sensed signal; and
determining the second intensity difference value according to the average value and the maximum value.

9. A control apparatus used in an edge detection device, wherein the edge detection device comprises a light emitting device, and receives an output light generated by the light emitting device driven by a driving signal in order to generate a sensed signal, the control apparatus comprising:
an adjusting module, for adjusting the driving signal;
a sensed signal intensity detecting module, for determining a first intensity difference value corresponding to a difference between high and low intensities of the sensed signal; and determining a second intensity difference value corresponding to a difference between high and low intensities of the sensed signal in response to adjusting of the driving signal by the adjusting module; and
an error calculating module, coupled to the sensed signal intensity detecting module, for comparing the first intensity difference value and the second intensity difference value to generate a comparison result;
wherein the adjusting module further adjusts the driving signal in accordance with the comparison result.

10. The control apparatus of claim 9, wherein:
the adjusting module increases an intensity of the driving signal when the comparison result indicates the first intensity difference value is smaller than the second intensity difference value; and
the adjusting module decreases the intensity of the driving signal when the comparison result indicates the first intensity difference value is greater than the second intensity difference value.

11. The control apparatus of claim 9, wherein:
the adjusting module increases an intensity of the driving signal when the comparison result indicates the first intensity difference value is greater than the second intensity difference value; and
the adjusting module decreases the intensity of the driving signal when the comparison result indicates the first intensity difference value is smaller than the second intensity difference value.

12. The control apparatus of claim 9, wherein:
the adjusting module increases an intensity of the driving signal when the comparison result indicates the first intensity difference value is greater than the second intensity difference value; and
the adjusting module decreases the intensity of the driving signal if increasing of the intensity of the driving signal makes the comparison result indicate the first intensity difference value is greater than the second intensity difference value.

13. The control apparatus of claim 9, wherein the adjusting module comprises:
the error calculating module, for calculating an error value between the first intensity difference value and the second intensity difference value;
a filtering module, coupled to the error calculating module, for performing a filtering operation on the error value to generate a filtered result;
an integrator module, coupled to the filtering module, for performing an integration operation on the filtered result to generate an integration result; and
a driving signal adjusting module, coupled to the integrator module, for adjusting the driving signal according to the integration result.

14. The control apparatus of claim 13, wherein the adjusting module further comprises:
a slope converting module, coupled between the integrator module and the driving signal adjusting module, for performing a slope conversion on the integration result to generate a driving signal compensation value, wherein the driving signal adjusting module adjusts the driving signal according to the driving signal compensation value;
wherein the slope converting module operates based on a relation between the first intensity difference value and the second intensity difference value in response to adjusting of the driving signal.

15. The control apparatus of claim 9, wherein the sensed signal intensity detecting module performs the following operations:
determining an average value of the sensed signal over a specific period of time;
determining a maximum value of the sensed signal; and
determining the first intensity difference value according to the average value and the maximum value.

16. The control apparatus of claim 9, wherein the sensed signal intensity detecting module performs the following operations:
determining an average value of the sensed signal over a specific period of time;
determining a maximum value of the sensed signal; and
determining the second intensity difference value according to the average value and the maximum value.
